(19) United States
(12) Patent Application Publication
(10) Pub. No.: US 2005/0060341 A1
(43) Pub. Date: Mar. 17, 2005

(54) Attachment file processing system and attachment file processing method

(76) Inventor: Toshio Shiina, Kanagawa (JP)

Correspondence Address: MORRISON & FOERSTER LLP, 1650 TYSONS BOULEVARD, SUITE 300, MCLEAN, VA, 22102, US

(21) Appl. No.: 10/909,917

(22) Filed: Aug. 3, 2004

(30) Foreign Application Priority Data
Aug. 4, 2003 (JP) 2003-286100

(51) Int. Cl. G06F 17/00

(52) U.S. Cl. 707/102

(57) ABSTRACT

An e-mail management server receives an e-mail destined to a portable terminal, which has an attachment file attached, separates the e-mail to the text and the attachment file, stores the attachment file, adds the address of the attachment file, and sends it to the portable terminal. When the portable terminal writes the e-mail (text and URL) to a recording medium, and a first printer or a second printer reads the e-mail from the recording medium and sends the address to the e-mail management server, the e-mail management server controls the first printer or the second printer to obtain image data that represents the attachment file. The first printer or the second printer obtains the image data, determines the number of sheets to be printed and printing fee, carries out printing, and carries out charging of the printing fee towards the user.

### BACKGROUND OF THE INVENTION

1. Field of the Invention

The present invention relates to an attachment file processing system and an attachment file processing method for printing data attached to an e-mail, etc.

2. Description of the Related Art

E-mail, which is widely used in recent years, can have a form where image data or data having a dedicated data format for a specific application program, is attached to a text constituted by text data, as an attachment file (for example, MIME (Multipurpose Internet Mail Extensions) format). In this case, the text and the attachment file attached to the text can be sent/received integrally. In a case where a printer is connected to the terminal which receives the e-mail, (or in a case where the terminal comprises a printer), in addition to the text of the e-mail, the content of the attachment file can also be printed.

However, there are cases where, at the side of the terminal that receives e-mail, it is not necessary to carry out printing, or cases where the e-mail can not be printed. In order to solve the above problem, an art of enabling a user to arbitrarily select whether to print the attachment file, at the side of the terminal that receives e-mail, is proposed in for example, Unexamined Japanese Patent Application KOKAI Publication No. 2003-44413. The content of the Publication is incorporated herein by reference in its entirety.

### SUMMARY OF THE INVENTION

However, in a case where the attachment file can not be printed by the side of the terminal that receives an e-mail, there is no meaning in simply having the user select whether to carry out printing or not, because printing can not be carried out at the side of that terminal. On the other hand, in a case where the terminal that receives the e-mail is a terminal such as a portable terminal, in many cases, the attachment file can not be printed or browsed. In order to confirm the content of the attachment file, it is convenient for the users of these kinds of terminals to obtain a hardcopy of the attachment file. Therefore, a structure that can provide a hardcopy of the attachment file, also to users of these kinds of terminals, is desired.

In this regard, in a case where a hardcopy of an attachment file is provided to a user of a terminal, there are cases where it is necessary to carry out adequate charging for the hardcopy. For example, there is a case where the hardcopy is copyrighted, or a case where the providing of the hardcopy is carried out for the purposes of profit-making business.

The present invention has been made in consideration of the above, and an object of the present invention is to provide an attachment file processing system and an attachment file processing method for providing a hardcopy of an attachment file of an e-mail, to users of a terminal, in a case where it is difficult to browse and print the attachment file of the e-mail.

Another object of the present invention is to provide an attachment file processing system and an attachment file processing method for carrying out adequate charging, at the time of providing the hardcopy of the attachment file of the e-mail.

To achieve the above objects, an attachment file processing system according to a first aspect of the present invention, is constituted by a server, a terminal, and a printing apparatus, wherein
the server:
receives e-mail including a text and an attachment file attached to the text, via a network;
separates the received e-mail to the text and the attachment file, and stores the separated attachment file; and
adds an address of a storing position where the attachment file attached to the text is stored, to the separated text, and sends the address to an external terminal which corresponds to the destination of the text, via the network,
the terminal stores to an recording medium, the address of the storing position where the attachment file is stored, which is sent from the server,
the printing apparatus reads from the recording medium, the address of the storing position where the attachment file is stored, and sends the address to the server, via the network,
the server receives the address of the attachment file from the printing apparatus, via the network, and sends data representing the attachment file stored in the storing position where the address indicates, to the printing apparatus via the network, and
the printing apparatus:
obtains the data sent from the server, via the network;
determines a charging amount based on the data; and
prints the attachment file that the data represents, and outputs the data representing the determined charging amount.

According to this kind of attachment file processing system, an attachment file is stored, separated from the text of an e-mail, and an address of the storing position of the attachment file is notified to the terminal, instead of the attachment file itself. Then, the terminal writes the address of the attachment file to a recording medium, and controls a printing apparatus to read the address of the attachment file from the recording medium, so that the attachment file is processed by the printing apparatus. Therefore, even if it is difficult for the terminal, which is a destination of the e-mail that has an attachment file attached, to browse or print the attachment file, the hardcopy of the attachment file is provided to the user of the terminal. Also, because the printing apparatus determines a charging amount, based on the data that represents the attachment file, and outputs the determined result, an adequate charging is carried out.

An attachment file processing system according to a second aspect of the present invention, is constituted by a server, a terminal, and a printing apparatus which can be connected to the terminal, wherein
the server:
receives e-mail including a text and an attachment file attached to the text, via a network;
separates the received e-mail to the text and the attachment file, and stores the separated attachment file; and
adds an address of a storing position where the attachment file attached to the text is stored, to the separated text, and sends the address to an external terminal which corresponds to the destination of the text, via the network,
the terminal stores to an recording medium, the address of the storing position where the attachment file is stored, which is sent from the server,
the printing apparatus reads from the recording medium, the address of the storing position where the attachment file is stored, and sends the address to the server, via the terminal and the network, when the printing apparatus is in a state where it is connected to the terminal,
the server receives the address of the attachment file from the printing apparatus, via the terminal and the network, and sends data representing the attachment file stored in the storing position where the address indicates, to the terminal via the network, and
the printing apparatus:
obtains from the terminal, the data that is sent to the terminal from the server;
determines a charging amount based on the data; and
prints the attachment file that the data represents, and outputs the data representing the determined charging amount.

According to this kind of attachment file processing system, an attachment file is stored, separated from the text of an e-mail, and an address of the storing position of the attachment file is notified to the terminal, instead of the attachment file itself. Then, the terminal writes the address of the attachment file to a recording medium, and if the terminal controls a printing apparatus to read the address of the attachment file from the recording medium, the printing apparatus obtains the data representing the attachment file, via the terminal, and processes the data. Therefore, even if it is difficult for the terminal, which is a destination of the e-mail that has an attachment file attached, to browse or print the attachment file, the hardcopy of the attachment file is provided to the user of the terminal. Also, because the printing apparatus determines a charging amount, based on the data that represents the attachment file, and outputs the determined result, an adequate charging is carried out.

The server may authenticate a user or a terminal, using authentication data for authenticating the user or the terminal, supplied together with the address, when receiving the address of the attachment file from the printing apparatus, via the network, and may stop processing of sending data that represents the attachment file to the printing apparatus, in a case where authentication fails.

Having this kind of structure, the attachment file processing system is protected from usage by an unauthorized user, or an unauthorized terminal.

An attachment file processing method according to a third aspect of the present invention, wherein:
a server:
receives e-mail including a text and an attachment file attached to the text, via a network;
separates the received e-mail to the text and the attachment file, and stores the separated attachment file; and
adds an address of a storing position where the attachment file attached to the text is stored, to the separated text, and sends the address to an external terminal which corresponds to the destination of the text, via the network,
the terminal stores to a recording medium, the address of the storing position where the attachment file is stored, which is sent from the server,
a printing apparatus reads from the recording medium, the address of the storing position where the attachment file is stored, and sends the address to the server, via the network,
the server receives the address of the attachment file from the printing apparatus, via the network, and sends data representing the attachment file stored in the storing position where the address indicates, to the printing apparatus via the network, and
the printing apparatus:
obtains the data sent from the server, via the network;
determines a charging amount based on the data; and
prints the attachment file that the data represents, and outputs the data representing the determined charging amount.

According to this kind of attachment file processing method, an attachment file is stored, separated from the text of an e-mail, and an address of the storing position of the attachment file is notified to the terminal, instead of the attachment file itself. Then, the terminal writes the address of the attachment file to a recording medium, and controls a printing apparatus to read the address of the attachment file from the recording medium, so that the attachment file is processed by the printing apparatus. Therefore, even if it is difficult for the terminal, which is a destination of the e-mail that has an attachment file attached, to browse or print the attachment file, the hardcopy of the attachment file is provided to the user of the terminal. Also, because the printing apparatus determines a charging amount, based on the data that represents the attachment file, and outputs the determined result, an adequate charging is carried out.

An attachment file processing method according to a fourth aspect of the present invention, wherein:
a server:
receives e-mail including a text and an attachment file attached to the text, via a network;
separates the received e-mail to the text and the attachment file, and stores the separated attachment file; and
adds an address of a storing position where the attachment file attached to the text is stored, to the separated text, and sends the address to an external terminal which corresponds to the destination of the text, via the network,
the terminal stores to a recording medium, the address of the storing position where the attachment file is stored, which is sent from the server,
a printing apparatus reads from the recording medium, the address of the storing position where the attachment file is stored, and sends the address to the server, via the network, when the printing apparatus is in a state where it is connected to the terminal,
the server receives the address of the attachment file from the printing apparatus, via the terminal and the network, and sends data representing the attachment file stored in the storing position where the address indicates, to the terminal via the network, and
the printing apparatus:
obtains from the terminal, the data that is sent to the terminal from the server;
determines a charging amount based on the data; and
prints the attachment file that the data represents, and outputs the data representing the determined charging amount.

According to this kind of attachment file processing system, an attachment file is stored, separated from the text of an e-mail, and an address of the storing position of the attachment file is notified to the terminal, instead of the attachment file itself. Then, the terminal writes the address of the attachment file to a recording medium, and if the terminal controls a printing apparatus to read the address of the attachment file from the recording medium, the printing apparatus obtains the data representing the attachment file, via the terminal, and processes the data. Therefore, even if it is difficult for the terminal, which is a destination of the e-mail that has an attachment file attached, to browse or print the attachment file, the hardcopy of the attachment file is provided to the user of the terminal. Also, because the printing apparatus determines a charging amount, based on the data that represents the attachment file, and outputs the determined result, an adequate charging is carried out.

An attachment file processing system according to a fifth aspect of the present invention is constituted by a server, a terminal, and a printing apparatus, wherein
the server comprises:
an e-mail receiving unit which receives e-mail including a text and an attachment file attached to the text, via a network;
an attachment file storing unit which separates the received e-mail to the text and the attachment file, and stores the separated attachment file;
an e-mail sending unit which adds an address of a storing position where the attachment file attached to the text is stored, to the separated text, and sends the address to an external terminal which corresponds to the destination of the text, via the network, and
a data sending unit which receives the address of the attachment file, reads the data that represents the attachment file stored in the storing position that the address indicates, from the attachment file storing unit,
the terminal comprises a storing unit which stores to an recording medium, the address of the storing position where the attachment file is stored, sent from the e-mail sending unit,
the printing apparatus comprises:
an address sending unit which reads from the recording medium, the address of the storing position where the attachment file is stored, and sends the address to the server, via the network,
a data receiving unit which obtains the data sent from the data sending unit, via the network;
a charging amount calculating unit which calculates a charging amount based on the data received in the data receiving unit;
an output unit which prints the attachment file that the data received in the data receiving unit represents, and outputs the charging amount calculated in the charging amount calculating unit; and
the data sending unit receives the address of the attachment file, sent from the address sending unit, via the network.

An attachment file processing system according to a sixth aspect of the present invention is constituted by a server, a terminal, and a printing apparatus, wherein
the server comprises:
an e-mail receiving unit which receives e-mail including a text and an attachment file attached to the text, via a network;
an attachment file storing unit which separates the received e-mail to the text and the attachment file, and stores the separated attachment file;
an e-mail sending unit which adds an address of a storing position where the attachment file attached to the text is stored, to the separated text, and sends the address to an external terminal which corresponds to the destination of the text, via the network; and
a data sending unit which receives the address of the attachment file, reads the data that represents the attachment file stored in the storing position that the address indicates, from the attachment file storing unit,
the terminal comprises a storing unit which stores to an recording medium, the address of the storing position where the attachment file is stored, sent from the e-mail sending unit,
the printing apparatus comprises:
an address sending unit which reads from the recording medium, the address of the storing position where the attachment file is stored, and sends the address to the server, via the terminal and the network, when the printing apparatus is in a state where it is connected to the terminal;
a data receiving unit which obtains the data sent from the data sending unit, via the network;
a charging amount calculating unit which calculates a charging amount based on the data received in the data receiving unit;
an output unit which prints the attachment file that the data received in the data receiving unit represents, and outputs the charging amount calculated in the charging amount calculating unit; and
the data sending unit receives the address of the attachment file, sent from the address sending unit, via the terminal and network.

An attachment file processing system according to a seventh aspect of the present invention, is constituted by a server, a terminal, a printing apparatus, and a charging device connected to the printing apparatus, wherein
the server comprises:
an e-mail receiving unit which receives e-mail including a text and an attachment file attached to the text, via a network;
an attachment file storing unit which separates the received e-mail to the text and the attachment file, and stores the separated attachment file;
an e-mail sending unit which adds an address of a storing position where the attachment file attached to the text is stored, to the separated text, and sends the address to an external terminal which corresponds to the destination of the text, via the network; and
a data sending unit which receives the address of the attachment file, reads the data that represents the attachment file stored in the storing position that the address indicates, from the attachment file storing unit,
the terminal comprises a storing unit which stores to an recording medium, the address of the storing position where the attachment file is stored, sent from the e-mail sending unit,
the printing apparatus comprises:
an address sending unit which reads from the recording medium, the address of the storing position where the attachment file is stored, and sends the address to the server, via the terminal and the network, when the printing apparatus is in a state where it is connected to the terminal;
a data receiving unit which obtains the data sent from the data sending unit, via the network;
a charging amount calculating unit which calculates a charging amount based on the data received in the data receiving unit, and
an output unit which prints and outputs the attachment file that the data received in the data receiving unit represents,
the charging device comprises a charging unit which collects the charging amount calculated in the charging amount calculating unit,
the data sending unit receives the address of the attachment file sent by the address sending unit via the terminal and the network, and
the output unit carries out printing, in a case where the charging amount is collected at the charging unit.

According to this invention, an attachment file processing system and an attachment file processing method for providing a hardcopy of an attachment file, to a user of terminal which is difficult to browse or print the attachment file of an e-mail, are realized.

Also, according to this invention, an attachment file processing system and an attachment file processing method carrying out adequate charging at the time of providing the hardcopy of the attachment file of the e-mail is realized.

### BRIEF DESCRIPTION OF THE DRAWINGS

These objects and other objects and advantages of the present invention will become more apparent upon reading of the following detailed description and the accompanying drawings in which:

FIG. 1 is a block diagram showing a structure of an attachment file output system according to an embodiment of the present invention;

FIG. 2 is a block diagram showing a structure of a portable terminal shown in FIG. 1;

FIG. 3 is a block diagram showing a structure of an e-mail management server shown in FIG. 1;

FIG. 4 is a block diagram showing a structure of a printer connected to a network shown in FIG. 1;

FIG. 5 is a block diagram showing a structure of a printer that is connected to the portable terminal in FIG. 1;

FIG. 6 is a flowchart showing processing carried out by an attachment file output system in FIG. 1, and

FIG. 7 is a flowchart continuing from FIG. 6.

### DETAILED DESCRIPTION OF TE PREFERRED EMBODIMENT

Below, an embodiment of the present invention will be described with reference to the drawings, In the present embodiment, an attachment file output system for printing an attachment file attached to an e-mail, will be described as an example.

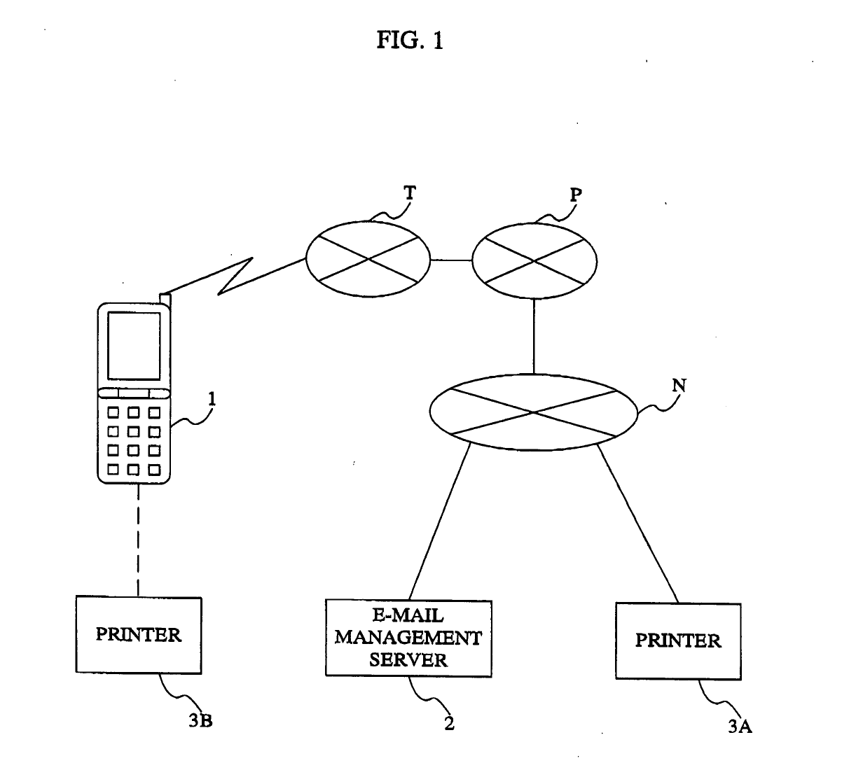

FIG. 1 is a diagram showing a structure of an attachment file output system according to an embodiment of the present invention.

As shown in the drawing, the attachment file output system is constituted by a portable terminal 1, an e-mail management server 2, a printer 3A, and a printer 3B. A telephone number and an address which are unique to the portable terminal 1, are allotted, and an identification code (for example, IP address) unique to each of the e-mail management server 2 and the printer 3A, is allotted.

The portable terminal 1 has a portable structure, and carries out functions of a terminal, such as a mobile phone (for example, cellular phone or PHS (Personal Handyphone System)) and a GSM (Global System for Mobile communications), etc. The portable terminal 1 is connected to an external packet-switched network P via an external telephone line network T, including a wireless communication line.

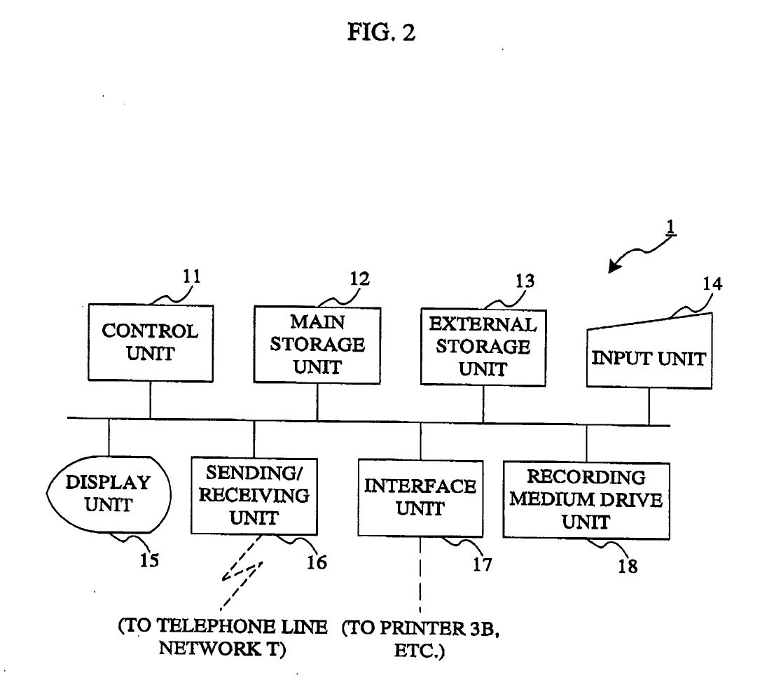

For example, as shown in FIG. 2, the portable terminal 1 is constituted by a control unit 11, a main storage unit 12, an external storage unit 13, an input unit 14, a display unit 15, a sending/receiving unit 16, an interface unit 17, and a recording medium drive unit 18. Each of the main storage unit 12, the external storage unit 13, the input unit 14, the display unit 15, the sending/receiving unit 16, the interface unit 17, and the recording medium drive unit 18 is connected to the control unit 11 via an internal bus.

The control unit 11 is constituted by a processor, such as a CPU (Central Processing Unit), etc., and executes the later described processing, in accordance with a program that the program data stored in the external storage unit 13 represents.

The main storage unit 12 is constituted by a volatile memory such as RAM (Random Access Memory), etc., and is used as an operation region of the control unit 11.

The external storage unit 13 is constituted by a non-volatile memory such as a flash memory, etc., and stores in advance, data of programs, etc., for controlling the control unit 11 to execute the later descried processing, and supplies the data that the external storage unit 13 stores, to the control unit 11, in accordance with instructions from the control unit 11.

The input unit 14 is constituted by a button and a switch, etc., and supplies information to the control unit 11, in accordance with operation by the operator.

The display unit 15 is constituted by an LCD (Liquid Crystal Display), etc., and displays an image in accordance with instructions from the control unit 11 on a displaying screen that the display unit 15 comprises.

The sending/receiving unit 16 is constituted by a wireless transmitter and a wireless receiver, etc., and is connected to the control unit 11 via the internal bus.

The sending/receiving unit 16 modulates a carrier wave by a predetermined format using information supplied by the control unit 11, and sends the obtained modulation wave via the telephone line network T (or directly), to the packet-switched network P. The sending/receiving unit 16 receives the modulation wave that represents the information destined to the portable terminal 1 (for example, information having added the address of the portable terminal 1), from the packet-switched network P via the telephone line network T. The sending/receiving unit 16 demodulates the modulation wave, and supplies the obtained information destined to the portable terminal 1 to the control unit 11.

The telephone line network T includes a base station used in communication between telephones, such as mobile phones and stationary phones, etc., and is connected to the packet-switched network P. The telephone line network T receives and modulates the modulation wave that the sending/receiving unit 16 of the terminal 1 sends, and sends the information obtained by modulation to the packet-switched network P, destined to an external apparatus (for example, another portable terminal, etc.) that the destination indicates. Also, the telephone line network T receives the information sent to the packet-switched network P destined to the portable terminal 1 from another external apparatus, from the packet-switched network P, and generates a modulation wave representing the received information, and sends it to the portable terminal 1.

The packet-switched network P intermediates switching of information between apparatuses that are connected to the packet-switched network P, and intermediates switching of information between an apparatus connected to the packet-switched network P and an apparatus that is not connected to the packet-switched network P, via the network N. The network N is constituted by for example, the Internet.

The interface unit 17 is constituted by a USB (Universal Serial Bus) controller, etc. The interface unit 17 intermediates serial transfer carried out between the control unit 11 and a device connected to the interface unit 17.

The recording medium drive unit 18 is constituted by a recording medium drive device which accesses to a recording medium (for example, SD memory (trademark), Smart Media (registered trademark), memory stick (trademark), etc.). The recording medium drive unit 18 accesses to the recording medium set thereto, in accordance with instructions from the control unit 11, reads data from the recording medium and supplies it to the control unit 11, and writes the data that the control unit 11 supplies, to the recording medium.

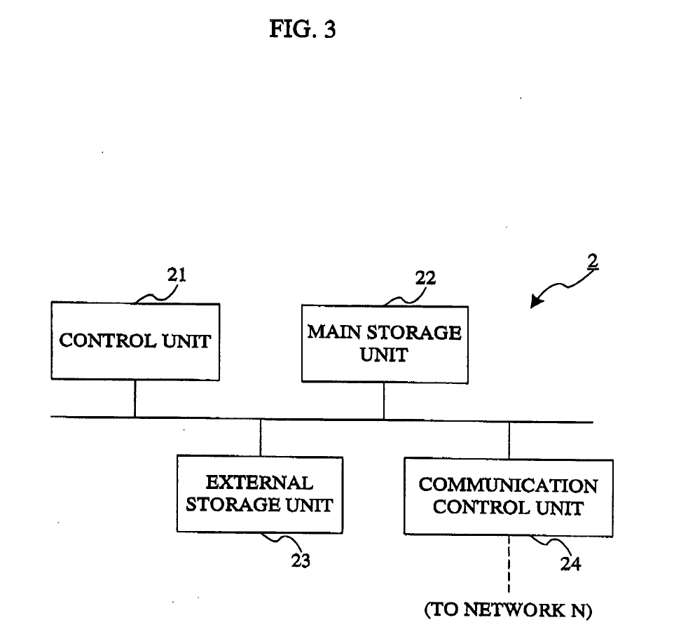

For example, as shown in FIG. 3, the e-mail management server 2 is constituted by a control unit 21, a main storage unit 22, an external storage unit 23, and a communication control unit 24. Each of the main storage unit 22, the external storage unit 23, and the communication control unit 24, is connected to the control unit 21 via the internal bus.

The control unit 21 is constituted by a processor such as a CPU, etc., and carries out the later described processing, in accordance with a program stored in the external storage unit 23.

The main storage unit 22 is constituted by a volatile memory such as RAM, and is used as an operation region of the control unit 21.

The external storage unit 23 is constituted by a non-volatile memory such as a hard disk device, etc., and stores in advance, programs for controlling the control unit 21 to carry out later-described processing, and data such as user information database. The external storage unit 23 stores data supplied by the control unit 21, in accordance with instructions from the control unit 21, and supplies the data stored in the external storage unit 23, to the control unit 21.

The user information database that the external storage unit 23 stores, stores the address allotted to the portable terminal 1 that the user uses, and the user ID allotted to the user, corresponding to each other.

The communication control unit 24 is constituted by a modem, etc., and is connected to the control unit 21 via the internal bus, and to the network N. The communication control unit 24 intermediates data exchange via the network N, between the control unit 21 and the external apparatus, in accordance with instructions from the control unit 21.

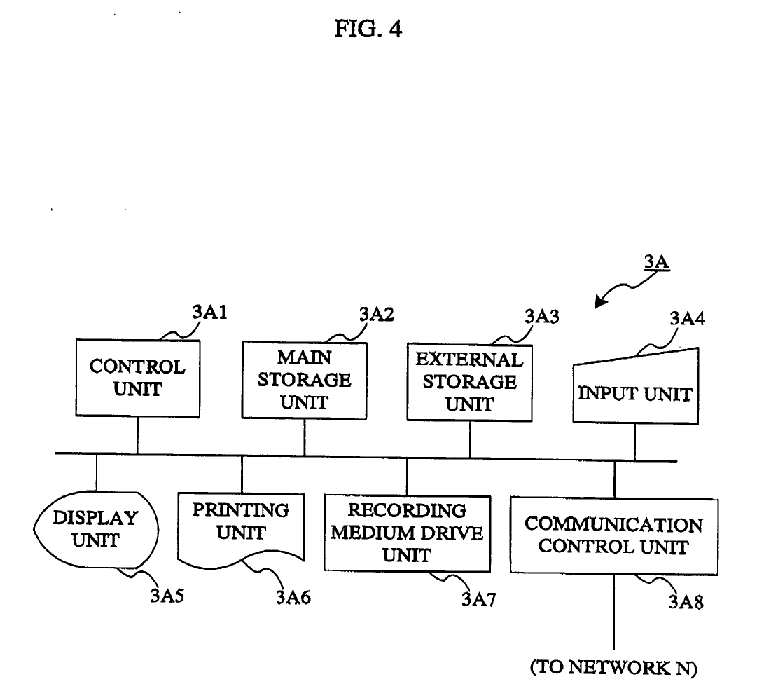

For example, as shown in FIG. 4, a printer 3A is constituted by a control unit 3A1, a main storage unit 3A2, an external storage unit 3A3, an input unit 3A4, a display unit 3A5, a printing unit 3A6, a recording medium drive unit 3A7, and a communication control unit 3A8. Each of the main storage unit 3A2, the external storage unit 3A3, the input unit 3A4, the display unit 3A5, the printing unit 3A6, the recording medium drive unit 3A7, and the communication control unit 3A8 is connected to the control unit 3A1, via the internal bus.

The control unit 3A1 is constituted by a processor, such as a CPU (Central Processing Unit), etc., and executes the later described processing, in accordance with a program stored in the external storage unit 3A3.

The main storage unit 3A2 is constituted by a volatile memory such as RAM (Random Access Memory), etc., and is used as an operation region of the control unit 3A1.

The external storage unit 3A3 is constituted by a non-volatile memory such as a hard disk device, etc., and stores in advance, data of programs, etc., for controlling the control unit 3A1 to execute the later descried processing. The external storage unit 3A3 stores the data supplied by the control unit 3A1, and supplies the data that the external storage unit 3A3 stores, and other data, to the control unit 3A1 in accordance with instructions from the control unit 3A1.

The input unit 3A4 is constituted by a touch panel, etc., and supplies information to the control unit 3A1, in accordance with operation by the operator.

The display unit 3A5 is constituted by an LCD, etc., and displays an image in accordance with instructions from the control unit 3A1 on a displaying screen that the display unit 3A5 comprises.

The printing unit 3A6 is constituted by a printer head and a sheet feeder, etc., and prints characters and figures, in accordance with instructions supplied from the control unit 3A1, to a surface of a sheet made of paper, etc.

The recording medium drive unit 3A7 is constituted by a recording medium drive device which accesses to a recording medium that can be accessed by the recording medium drive unit 18 of the portable terminal 1. The recording medium drive unit 3A7 accesses to the recording medium set thereto, in accordance with instructions from the control unit 3A1, reads data from the recording medium and supplies it to the control unit 11, and writes the data that the control unit 3A1 supplies, to the recording medium.

The communication control unit 3A8 is constituted by a modem, etc., and is connected to the control unit 3A1 via the internal bus, and to the network N. The communication control unit 3A8 intermediates data exchange via the network N, between the control unit 3A1 and the external apparatus, in accordance with instructions from the control unit 3A1.

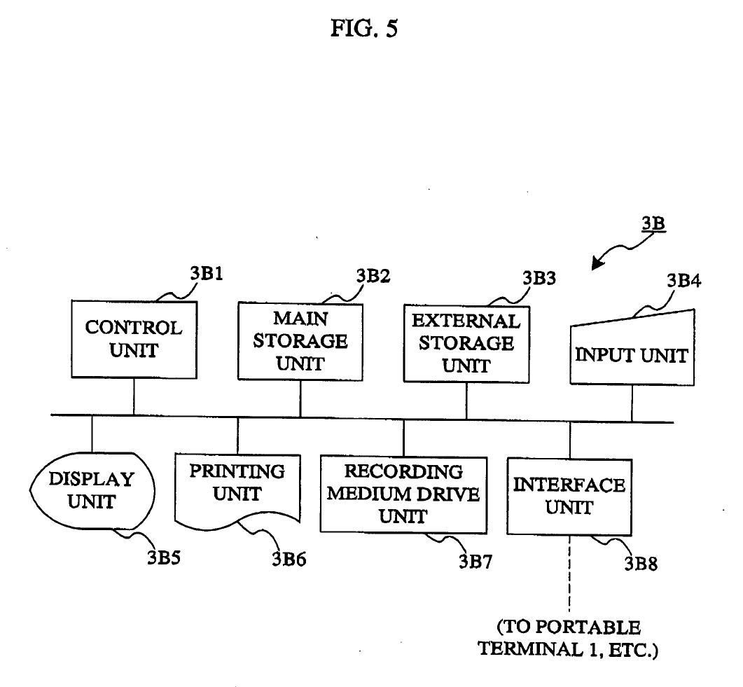

For example, as shown in FIG. 5, a printer 3B is constituted by a control unit 3B1, a main storage unit 3B2, an external storage unit 3B3, an input unit 3B4, a display unit 3B5, a printing unit 3B6, a recording medium drive unit 3B7, and an interface unit 3B8. Each of the main storage unit 3B2, the external storage unit 3B3, the input unit 3B4, the display unit 3B5, the printing unit 3B6, the recording medium drive unit 3B7, and the interface unit 3138 is connected to the control unit 3B1, via the internal bus. The control unit 3B1, the main storage unit 3B2, the external storage unit 3B3, the input unit 3B4, the display unit 3B5, the printing unit 3B6, the recording medium drive unit 3B7 are substantially the same as the control unit 3A1, the main storage unit 3A2, the external storage unit 3A3, the input unit 3A4, the display unit 3A5, the printing unit 3A6, the recording medium drive unit 3A7 of the printer 3A. However, the printer 3B differs from the printer 3A, in that the printer 3B does not have a function which is directly connected to the network N.

The interface unit 3B8 of the printer 3B is constituted by a serial interface circuit such as a USB controller, etc., and intermediates serial transmission carried out between the control unit 3B1 and a device connected to the interface unit 3B8.

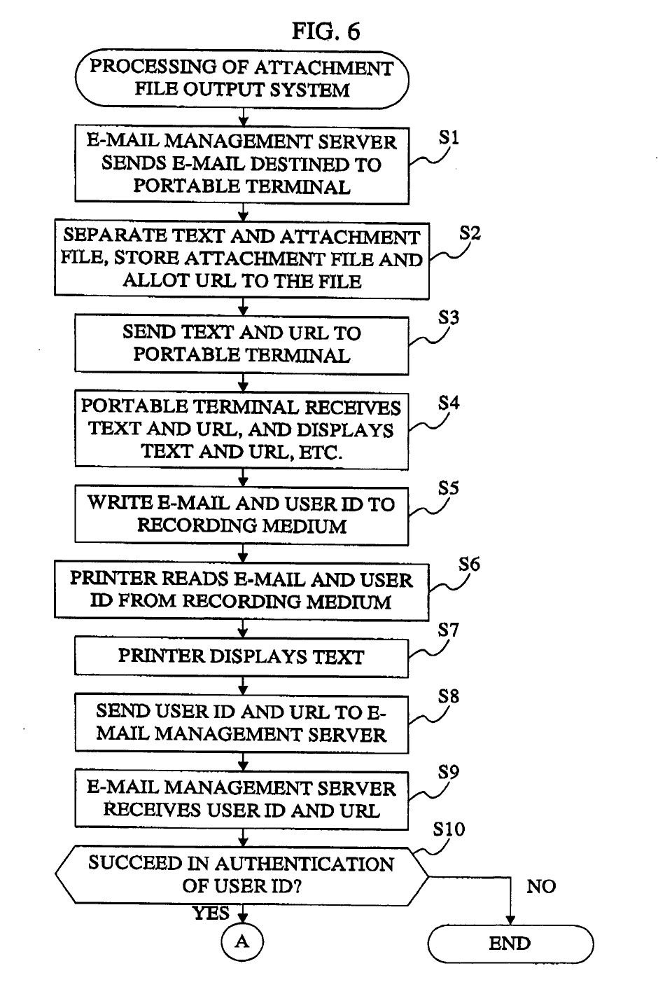

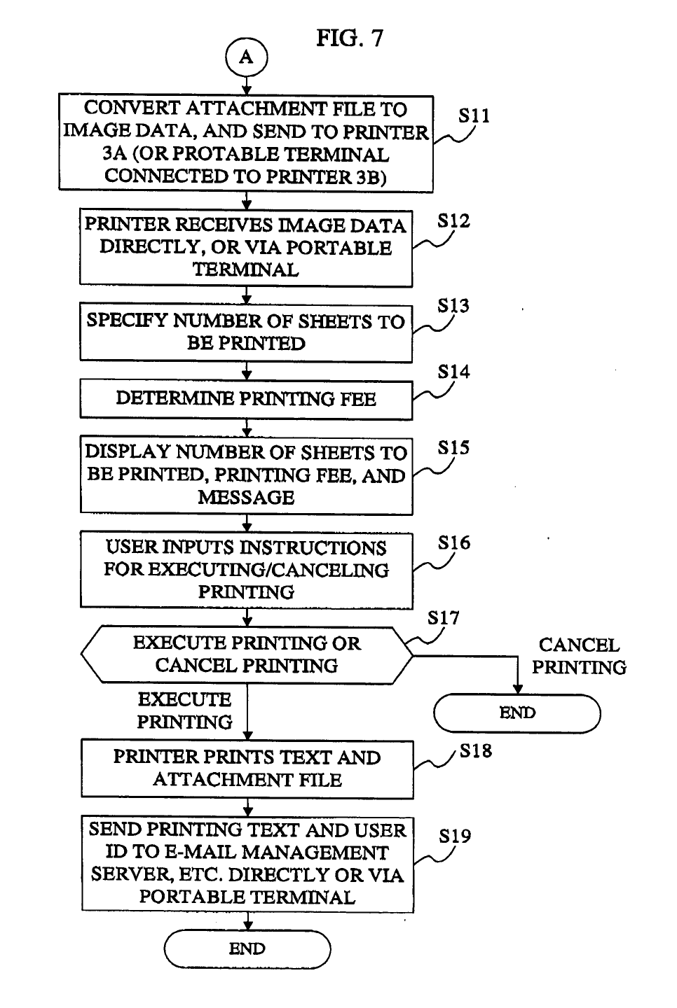

Next, operation of the attachment file output system will be described with reference to FIGS. 6 and 7. FIGS. 6 and 7 are drawings showing the entire operation of the attachment file output system.

First, when an e-mail destined to the portable terminal 1, that has an attachment file attached, is sent to the network N, the control unit 21 of the e-mail management server 2 receives the e-mail via the communication control unit 24 (FIG. 6, step S1).

Next, the control unit parses the message text of the e-mail received in step S1, and separates the e-mail to the text and the attachment file. Then, the control unit 21 stores the separated attachment file to a storage region of the external storage unit 23, and allots a unique URL (Uniform Resource Locator) to the attachment file, at a storing position where the attachment file is stored (step S2).

Next, the control unit 21 adds the URL of the attachment file allotted in step S2, to the text of the e-mail separated in step S2, and sends the text and the URL to the network N, destined to the portable terminal 1, which is the original destination (step S3).

The network N sends the text and the URL sent in step S3 to the packed-switched network P, and the packet-switched network P sends the text to the portable terminal 1, via the telephone line network T.

The control unit 11 of the portable terminal 1 receives the text and URL sent by the e-mail management server 2 and transferred to the network N, the packet-switched network P, and the telephone line network T, in step S3, via the sending/receiving unit 16, and displays the text on the display screen of the display unit 15 (step S4). Also, in step S4, the control unit 11 also displays characters (for example, received URL) or drawings, indicating that an attachment file is attached to the text.

Then, the user, etc., of the portable terminal 1 sets a recording medium to the recording medium drive unit 18, and operates the input unit 14 to input the user ID allotted to the user of the portable terminal 1 and instructions for writing-in e-mail. The control unit 11 controls the recording medium derive unit 18 to write the user ID and the e-mail (text and URL of the attachment file) received in step S4, to the recording medium (step S5).

When the user, etc., sets the recording medium that has the e-mail and the user ID written in, in step S5, to the recording medium drive unit 3A7 of the printer 3A, the recording medium drive unit 3A7 reads the e-mail and the user ID from the recording medium, and supplies them to the control unit 3A1 (step S6).

When the user ID and e-mail are supplied, the control unit 3A1 controls the display unit 3A5 to display the text of the e-mail (step S7). Next, the control unit 3A1 sends the supplied user ID and the URL included in the supplied e-mail (URL of the attachment file) to the network N, via the communication control unit 3A8, destined to the e-mail management server 2 (concretely, for example, by adding an IP address allotted to the e-mail management server 2) (step S8).

When the control unit 21 of the e-mail management server 2 receives the user ID and the URL of the attachment file sent by the printer 3A in step S8, from the network N, via the communication control unit 24 (step S9), the control unit 21 authenticates the received user ID (step S10). Concretely, for example, the control unit 21 determines whether the received user ID is the user ID allotted to the user of the portable terminal 1, by searching the user information database that the external storage unit 23 stores.

In a case where authentication fails, (namely, in a case where it is determined that the received user ID is not allotted to the user of the portable terminal 1), the control unit 21 ends the processing. On the other hand, in a case where authentication succeeds, (namely, in a case where it is determined that the received user ID is allotted to the user of the portable terminal 1), the control unit 21 reads the attachment file stored in the storing position that the URL received in step S9 indicates, converts the read attachment file to an image data of a data format that can be printed by the printer 3A, (for example, PostScript (registered trademark) format), and sends the obtained image data to the network N, destined to the printer 3A (FIG. 7, step S11). In a case where the attachment file is already in a data format that can be printed by the printer 3A, the control unit 21 does not have to carry out conversion of data format concerning the image data sent to the printer 3A, in step S1.

The control unit 3A1 of the printer 3A receives the image data that the e-mail management server 2 sends in step S11, from the network N, via the communication control unit 3A8 (step S12). The control unit 3A1 of the printer 3A analyzes the image data and parses the text of the e-mail supplied in step S7, and specifies the number of sheets that will be printed, in a case where the image data and the text of the e-mail is printed (step S13). In a case where there are a plurality of types of printing (for example, monochrome printing, color printing, printing at photographing image quality), the number of sheets to be printed is specified according to the type of printing.

Next, the control unit 3A1 calculates a printing fee which should be charged to the user of the portable terminal 1, based on the number of sheets that are to be printed, specified in step S13 (step S14). The calculating standard for the printing fee is arbitrary, and for example, the printing fee may be a value where a predetermined unit price is multiplied by the number of prints that are to be printed, specified in step S13. In a case where there a plurality of kinds of printing, and the unit price of printing is set according to the kind of printing, the product of the number of sheets that are to be printed multiplied by the unit price, is obtained according to the kind of printing, and the total amount of the obtained product may be the printing fee.

Then, the control unit 3A1 controls the display unit 3A5 to display the number of sheets that are to be printed, specified in step S13, the printing fee obtained in step S14, and a message urging the user to decide whether to carry out printing or not (step S15). The number of sheets to be printed, and the printing fee, may be displayed according to the kind of printing.

The user (the user of the portable terminal, etc.) who confirms the number of sheets to be printed, the printing fee, and the message, displayed in step S15, operates the input unit 3A4 to input instructions for executing printing, or for canceling printing (step S16).

The control unit 3A1 determines whether the instruction that the user inputs in step S16 is an instruction for executing printing or for canceling printing (step S17). In a case where the control unit 3A1 determines that the instruction is for canceling printing, it ends the processing. On the other hand, in a case where the control unit 3A1 determines that the instruction is for executing printing, it controls the printing unit 3A6 to print the image of the attachment file that the image data received in step S112 represents, and the text of the e-mail supplied in step S7 (step S18).

On the other hand, the control unit 3A1 sends the data that indicates the printing fee obtained in step S14 and the user ID supplied in step S6 to the e-mail management server 2 (or another arbitrary device) via the communication control unit 3A8 (step S19).

The device such as the e-mail management server 2, etc., that receives data indicating the printing fee, and the user ID, stores the data and the user ID. Then, it obtains the total amount of the printing fee during a predetermined period (for example, the last month), at a predetermined timing (for example, at each month-end), according to each user, and externally outputs the data that indicates the obtained total amount, as data indicating the charging amount to each user. As a result, charging of printing fee to each user is carried out.

Storing of the data that indicates the printing fee, calculating the total amount of the printing fee, and outputting of the data indicating the charging amount, may be carried out by the printer 3A. The printer 3A may output the data indicating the printing fee, the sum total of the printing fee, and the data indicating the charging amount, by carrying out printing.

The recording medium that has the user ID and the e-mail written, may be set to the recording medium drive unit 3137 of the printer 3B. In this case, in step S6, the recording medium drive unit 3B7 reads the user ID and e-mail from the recording medium, and supplies them to the control unit 3B1. However, in this case, the user, etc., of the portable terminal 1 connects the interface unit 17 of the portable terminal 1 and the interface unit 3B5 of the printer 3B with each other, via a cable, etc.

Then, in step S7, the control unit 3B1 controls the display unit 3B5 to display the text of the e-mail, and in step S8, supplies the supplied user ID and URL of the attachment file to the portable terminal 1, via the interface unit 3B8. Obtaining the user ID and the URL via the interface unit 17, the control unit 11 of the portable terminal 1 sends the user ID and URL to the telephone line network T, destined to the e-mail management server 2, via the sending/receiving unit 16. The sent user ID and URL is sent to the network N from the telephone line network T, via the packet-switched network P.

The control unit 21 of the e-mail management server 2 receives the user ID and URL of the attachment file which are sent via the portable terminal 1 from the printer 3B in step S8, from the network N, via the communication control unit 24 (FIG. 6, step S9), and in step S10, the control unit 21 authenticates the user ID in the same way as the above procedure. In a case where authentication fails, the control unit 21 ends the processing, and in a case where authentication succeeds, the control unit 21 reads the attachment file storing position that the URL indicates, converts the attachment file to an image data of a data format that can be printed by the printer 3B, and sends the image data to the network N, destined to the portable terminal 1 (FIG. 7, step S11).

The control unit 11 of the portable terminal 1 receives the image data sent by the e-mail management server 2 and transferred to the network N, the packet-switched network P, and the telephone line network T, via the sending/receiving unit 16, and supplies the image data the printer 3B, via the interface unit 17. When the control unit 3B1 of the printer 3B obtains the image data from the portable terminal 1, via the interface unit 3B8 (step S12), the control unit 3B1 carries out substantially the same processing that the printer 3A carries out in steps S13 to S19. The printer 3B may carry out the processing of sending data that indicates the printing fee in step S19, via the portable terminal 1.

According to the attachment file output system described above, in a case where an attachment file is attached to an e-mail sent to the portable terminal 1, the e-mail management server 2 separates the attachment file from the text of the e-mail, and stores it. Then, the e-mail management server 2 notifies the address of the storing position of the attachment file to the portable terminal 1, instead of the attachment file itself. Further, the portable terminal 1 writes the text of the e-mail and the address of the attachment file to the recording medium. In a case where the recording medium is set to the printer 3A or the printer 3B, the printer 3A or 3B sends the address of the attachment file to the e-mail management server, directly, or via the portable terminal 1, and obtains image data of the attachment file. Then, the number of sheets that are to be printed, and the printing fee of the text of the e-mail and the attachment file are obtained, and the text of the e-mail and the attachment file are printed, after being confirmed by the user. Therefore, even if an e-mail that has an attachment file attached, is sent to a portable terminal 1 that can not display the attachment file, printing of the attachment file can be carried out. Then, a printing fee is charged to the user.

The structure of the attachment file output system is not limited to the above structure.

For example, the attachment file output system may comprise a plurality of portable terminals 1, printers 3A, and printers 3B. In a case where the attachment file output system comprises a plurality of printers 3A, the portable terminal 1 may obtain information designating a targeted printer for printing the attachment file, in accordance with operations, etc., of the user, and send the information to the e-mail management server 2, in step S6. Then, in step S11, the e-mail management server 2 may send the image data representing the attachment file to the printer 3A designated by the information.

In step S10, the e-mail management server 2 does not necessarily have to carry out authentication of the user ID, and the processing may forward to step S11 immediately from step S9. In this case, it is not necessary for the printer 3A or the portable terminal 1 to send the user ID to the e-mail management server 2.

The portable terminal 1 may store the user ID in advance. In this case, it is not necessary for the portable terminal 1 to obtain the user ID in accordance with the operation of the user, etc., and the portable terminal 1 may write the user ID that is stored therein, to the recording medium, in step S5.

In step S10, instead of authenticating the user ID that is allotted to the user (or together with authenticating the user ID), the e-mail management server 2 may carry out authentication using an apparatus ID that is uniquely allotted to the printer 3A. In this case, in step S8, the printer 3A may send the apparatus ID of the printer itself together with the URL of the attachment file to the network N, destined to the e-mail management server 2.

In step S5, instead of writing the user ID and the URL of the attachment file, the portable terminal 1 may send the user ID and the URL of the attachment file to the telephone line network T, destined to the e-mail management server 2, in accordance with the operation of the user, etc. In this case, when the e-mail management server 2 receives the user ID and the URL sent from the portable terminal 1 in step S5, via the telephone line network T, the packet-switched network P, and the network N, the e-mail management server 2 may carry out the processing of steps S9 to S11, handling the received user ID and URL, in the same way as the user ID and URL sent from the printer 3A in step S3.

In a case where a printer 3B that has a charging device connected thereto, is placed at a convenience store, etc., and charging is carried out in accordance with the number of sheets that are printed, the attachment file output system may be structured, so that the text and attachment file are printed, when the user instructs printing execution, and puts in the printing fee to the charging device.

More concretely, before the processing of step S18 in FIG. 7, the printer 3B sends the data indicating the printing fee, obtained in step S14, to the charging device, and displays a message urging the printing fee to be put in, to the display unit 3B5. After the printing fee is put in by the user, the charging device sends information indicating that the fee has been put in by the user, to the printer 3B. Then, the processing of the above step S18 is executed.

Above, the embodiment of the present invention is described. However, the attachment file processing system according to the present invention can be achieved not only by a special system, but also by an ordinary computer system.

For example, the attachment file output system that executes the above processing can be constructed by installing a program for performing the operations of the above e-mail management server 2, stored in a medium (CD-ROM, MO, flexible disk, etc.), into a server computer which is connectable to a printer or a mobile phone that can carry out packet communication, via a network.

Alternatively, the program may be uploaded to a bulletin board system (BBS) of a communication network and distributed through the communication network, or a carrier may be modulated with a signal expressing the program, so that the acquired modulated wave may be demodulated to restore the program by an apparatus which receives the modulated wave.

As the program is activated and run, like other application programs, under the control of the OS, the above-described processing can be carried out.

In a case where the OS carries out a part of the processing, or the OS constitutes a part of a single constituting element of the present invention, the program including the part may be stored in the recording medium. Even in this case, it is premised that the program for executing the individual functions or steps that are executed by a computer, should be stored in the recording medium in the invention.

Various embodiments and changes may be made thereonto without departing from the broad spirit and scope of the invention. The above-described embodiments are intended to illustrate the present invention, not to limit the scope of the present invention. The scope of the present invention is shown by the attached claims rather than the embodiments. Various modifications made within the meaning of an equivalent of the claims of the invention and within the claims are to be regarded to be in the scope of the present invention.

This application is based on Japanese Patent Application No. 2003-286100 filed on Aug. 4, 2003 and including specification, claims, drawings and summary. The disclosure of the above Japanese Patent Application is incorporated herein by reference in its entirety.

1. An attachment file processing system constituted by a server, a terminal, and a printing apparatus, wherein
said server:
receives e-mail including a text and an attachment file attached to the text, via a network;
separates the received e-mail to the text and the attachment file, and stores the separated attachment file; and
adds an address of a storing position where the attachment file attached to the text is stored, to the separated text, and sends the address to an external terminal which corresponds to the destination of the text, via the network,
said terminal stores to an recording medium, the address of the storing position where the attachment file is stored, which is sent from said server,
said printing apparatus reads from said recording medium, the address of the storing position where the attachment file is stored, and sends the address to said server, via the network,
said server receives the address of the attachment file from the printing apparatus, via the network, and sends data representing the attachment file stored in the storing position where the address indicates, to the printing apparatus via the network, and
said printing apparatus:
obtains the data sent from said server, via the network;
determines a charging amount based on the data; and
prints the attachment file that the data represents, and outputs the data representing the determined charging amount.

2. The attachment file processing system according to claim 1, wherein said server:
authenticates a user or a terminal, using authentication data for authenticating the user or the terminal, supplied together with the address, when receiving the address of the attachment file from the printing apparatus, via the network; and
stops processing of sending data that represents the attachment file to the printing apparatus, in a case where authentication fails.

3. An attachment file processing system constituted by a server, a terminal, and a printing apparatus which can be connected to said terminal, wherein
said server:
receives e-mail including a text and an attachment file attached to the text, via a network;
separates the received e-mail to the text and the attachment file, and stores the separated attachment file; and
adds an address of a storing position where the attachment file attached to the text is stored, to the separated text, and sends the address to an external terminal which corresponds to the destination of the text, via the network,
said terminal stores to an recording medium, the address of the storing position where the attachment file is stored, which is sent from said server,
said printing apparatus reads from said recording medium, the address of the storing position where the attachment file is stored, and sends the address to said server, via the terminal and the network, when said printing apparatus is in a state where it is connected to said terminal,
said server receives the address of the attachment file from the printing apparatus, via the terminal and the network, and sends data representing the attachment file stored in the storing position where the address indicates, to the terminal via the network, and
said printing apparatus:
obtains from the terminal, the data that is sent to said terminal from said server;
determines a charging amount based on the data; and
prints the attachment file that the data represents, and outputs the data representing the determined charging amount.

4. The attachment file processing system according to claim 3, wherein said server:
authenticates a user or a terminal, using authentication data for authenticating the user or the terminal, supplied together with the address, when receiving the address of the attachment file from the printing apparatus, via the network; and
stops processing of sending data that represents the attachment file to the printing apparatus, in a case where authentication fails.

5. An attachment file processing method, wherein:
a server:
receives e-mail including a text and an attachment file attached to the text, via a network;
separates the received e-mail to the text and the attachment file, and stores the separated attachment file; and
adds an address of a storing position where the attachment file attached to the text is stored, to the separated text, and sends the address to an external terminal which corresponds to the destination of the text, via the network,
said terminal stores to a recording medium, the address of the storing position where the attachment file is stored, which is sent from said server,
a printing apparatus reads from said recording medium, the address of the storing position where the attachment file is stored, and sends the address to said server, via the network,
said server receives the address of the attachment file from the printing apparatus, via the network, and sends data representing the attachment file stored in the storing position where the address indicates, to the printing apparatus via the network, and
said printing apparatus:
obtains the data sent from said server, via the network;
determines a charging amount based on the data; and
prints the attachment file that the data represents, and outputs the data representing the determined charging amount.

6. An attachment file processing method, wherein:
a server:
receives e-mail including a text and an attachment file attached to the text, via a network;
separates the received e-mail to the text and the attachment file, and stores the separated attachment file; and
adds an address of a storing position where the attachment file attached to the text is stored, to the separated text, and sends the address to an external terminal which corresponds to the destination of the text, via the network,
said terminal stores to a recording medium, the address of the storing position where the attachment file is stored, which is sent from said server,
a printing apparatus reads from said recording medium, the address of the storing position where the attachment file is stored, and sends the address to said server, via the network, when said printing apparatus is in a state where it is connected to said terminal,
said server receives the address of the attachment file from the printing apparatus, via the terminal and the network, and sends data representing the attachment file stored in the storing position where the address indicates, to the terminal via the network, and
said printing apparatus:
obtains from the terminal, the data that is sent to said terminal from said server;
determines a charging amount based on the data; and
prints the attachment file that the data represents, and outputs the data representing the determined charging amount.

7. An attachment file processing system constituted by a server, a terminal, and a printing apparatus, wherein
said server comprises:
an e-mail receiving unit which receives e-mail including a text and an attachment file attached to the text, via a network;
an attachment file storing unit which separates the received e-mail to the text and the attachment file, and stores the separated attachment file;
an e-mail sending unit which adds an address of a storing position where the attachment file attached to the text is stored, to the separated text, and sends the address to an external terminal which corresponds to the destination of the text, via the network, and
a data sending unit which receives the address of the attachment file, reads the data that represents the attachment file stored in the storing position that the address indicates, from said attachment file storing unit,
said terminal comprises a storing unit which stores to an recording medium, the address of the storing position where the attachment file is stored, sent from said e-mail sending unit,
said printing apparatus comprises:
an address sending unit which reads from said recording medium, the address of the storing position where the attachment file is stored, and sends the address to said server, via the network;
a data receiving unit which obtains the data sent from the data sending unit, via the network;
a charging amount calculating unit which calculates a charging amount based on the data received in said data receiving unit; and
an output unit which prints the attachment file that the data received in said data receiving unit represents, and outputs the charging amount calculated in said charging amount calculating unit, and
said data sending unit receives the address of the attachment file, sent from said address sending unit, via said network.

8. The attachment file processing system according to claim 7, wherein:
said address sending unit sends authentication data for authenticating a user or a terminal, together with the address, and
said data sending unit authenticates the user or the terminal, using the authentication data supplied together with the address of the attachment file, via the network, and cancels the sending of the data representing the attachment file to the printing apparatus, in a case where authentication fails.

9. An attachment file processing system constituted by a server, a terminal, and a printing apparatus, wherein
said server comprises:
an e-mail receiving unit which receives e-mail including a text and an attachment file attached to the text, via a network;
an attachment file storing unit which separates the received e-mail to the text and the attachment file, and stores the separated attachment file;
an e-mail sending unit which adds an address of a storing position where the attachment file attached to the text is stored, to the separated text, and sends the address to an external terminal which corresponds to the destination of the text, via the network; and
a data sending unit which receives the address of the attachment file, reads the data that represents the attachment file stored in the storing position that the address indicates, from said attachment file storing unit,
said terminal comprises a storing unit which stores to an recording medium, the address of the storing position where the attachment file is stored, sent from said e-mail sending unit,
said printing apparatus comprises:
an address sending unit which reads from said recording medium, the address of the storing position where the attachment file is stored, and sends the address to said server, via the terminal and the network, when said printing apparatus is in a state where it is connected to said terminal;
a data receiving unit which obtains the data sent from the data sending unit, via the network;
a charging amount calculating unit which calculates a charging amount based on the data received in said data receiving unit;
an output unit which prints the attachment file that the data received in said data receiving unit represents, and outputs the charging amount calculated in said charging amount calculating unit; and
said data sending unit receives the address of the attachment file, sent from said address sending unit, via said terminal and network.

10. The attachment file processing system according to claim 9, wherein:
said address sending unit sends authentication data for authenticating a user or a terminal, together with the address, and
said data sending unit authenticates the user or the terminal, using the authentication data supplied together with the address of the attachment file, via the network, and cancels the sending of the data representing the attachment file to the printing apparatus, in a case where authentication fails.

11. An attachment file processing system constituted by a server, a terminal, a printing apparatus, and a charging device connected to the printing apparatus, wherein
said server comprises:
an e-mail receiving unit which receives e-mail including a text and an attachment file attached to the text, via a network;
an attachment file storing unit which separates the received e-mail to the text and the attachment file, and stores the separated attachment file;
an e-mail sending unit which adds an address of a storing position where the attachment file attached to the text is stored, to the separated text, and sends the address to an external terminal which corresponds to the destination of the text, via the network; and
a data sending unit which receives the address of the attachment file, reads the data that represents the attachment file stored in the storing position that the address indicates, from said attachment file storing unit,
said terminal comprises a storing unit which stores to an recording medium, the address of the storing position where the attachment file is stored, sent from said e-mail sending unit,
said printing apparatus comprises:
an address sending unit which reads from said recording medium, the address of the storing position where the attachment file is stored, and sends the address to said server, via the terminal and the network, when said printing apparatus is in a state where it is connected to said terminal;
a data receiving unit which obtains the data sent from the data sending unit, via the network;
a charging amount calculating unit which calculates a charging amount based on the data received in said data receiving unit; and
an output unit which prints and outputs the attachment file that the data received in said data receiving unit represents,
said charging device comprises a charging unit which collects the charging amount calculated in said charging amount calculating unit,
said data sending unit receives the address of the attachment file sent by the address sending unit via the terminal and the network, and
said output unit carries out printing, in a case where the charging amount is collected at the charging unit.

12. The attachment file processing system according to claim 11, wherein:
said address sending unit sends authentication data for authenticating a user or a terminal, together with the address, and
said data sending unit authenticates the user or the terminal, using the authentication data supplied together with the address of the attachment file, via the network, and cancels the sending of the data representing the attachment file to the printing apparatus, in a case where authentication fails.
